(19) United States
(12) Patent Application Publication
(10) Pub. No.: US 2005/0103633 A1
(43) Pub. Date: May 19, 2005

(54) Automatic inspection and imaging electrophoresis device

(76) Inventor: Chih-Yuan Tseng, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/714,647

(22) Filed: Nov. 18, 2003

(51) Int. Cl. G01N 27/453

(52) U.S. Cl. 204/607

(57) ABSTRACT

An automatic monitoring and imaging electrophoresis device. The device comprises a combined electrophoresis tank and electrophoresis analyzing equipment. The device further comprises features such as time setting, instant sensor, instant imaging, and automatic storage. It also contains components that provide a power source, sensor, light source, scanner, and storage; and an electrophoresis tray for samples in order to complete the operations of electrophoresis mobility and analysis with the same device. The electrophoresis analysis device overcomes the disadvantages of restricted operating mobility and separate analysis, as well as providing simplicity, safety and efficiency to users.

### BACKGROUND OF THE INVENTION

1. Field of the Invention

The present invention relates to an electrophoresis analysis device. More specifically, the present invention discloses an automatic inspection and imaging electrophoresis analysis device.

2. Description of the Prior Art

Electrophoresis is a very important technology in the molecule inspection field. Electrophoresis is a method of separating large molecules from a mixture of similar molecules. An electric current is passed through a medium containing the mixture, and each kind of molecule travels through the medium at a different rate, depending on its electrical charge and size. Separation is based on these differences.

Mobility is directly proportional to the electric density of a molecule; and is inversely proportional to the friction of the molecule. The friction is related to the size and shape of the molecule. If the mass of the molecule is large, then the friction is large. If the mobility is little, then the friction amongst the molecules is small. In an electrophoresis system, electrons flow from negative to positive; so the negative molecule flows to positive, the positive molecule flows to negative and the neutral molecule does not flow easily.

Electrophoresis requires a medium. In the early days, the operation was carried out in a liquid. However, liquid tends to expand. Therefore, a moist filter was applied, but the traction between filter and molecule was large, which caused overheating. Therefore, a semi-solid gel, such as starch gel electrophoresis, polyacrylamide gel electrophoresis (PAGE), agarose gel electrophoresis . . . etc., is now commonly used. Since there is large space between the long-chained molecules of the gel sheet, the friction amongst protein can be reduced and the sample volume can be increased. This is suitable for large molecule electrophoresis, such as nucleinase and protein, etc. Gel electrophoresis is widely used in advanced biotechnology.

General gel electrophoresis is performed by placing a pre-fabricated gel sheet in an electrophoresis tank. Then, the sample is placed on the gel sheet in the sample tank. Electricity is applied to perform electrophoresis. The duration of the electric input is set or determined by observation of the mobility. However, the distance and duration of mobility differ according to the sample.

During electrophoresis, timing cannot always be controlled precisely, which causes the result to have a poor resolution. Since the electrophoresis tank is only used for the process while inputting electricity to stimulate molecule mobility, after completing electrophoresis, the gel sheet has to be moved to another tank. After being exposed in UV light or other light source, an image is taken by a camera and stored.

The process of moving the gel sheet has to be performed very carefully. If there is any damage to the gel sheet, the analysis result will be affected. In order to enhance the electrophoresis result, dye is generally applied to the gel sheet. However, the commonly used Ethidium Bromide (EtBr) can cause cancer. Even when an operator uses gloves for protection, there is still risk of damage to their health.

In order to overcome the disadvantages mentioned above, the present invention provides an automatic image inspection electrophoresis device, which combines an electrophoresis chamber and analysis equipment and utilizes automation to control the electrophoresis process. The device of the present invention has the advantages of making electrophoresis analysis easier, safer, and more accurate.

### SUMMARY OF THE INVENTION

To achieve these and other advantages and in order to overcome the disadvantages of the conventional method in accordance with the purpose of the invention as embodied and broadly described herein, the present invention provides an automatic inspection and imaging electrophoresis analysis device which ensures the process of electrophoresis analysis is performed more efficiently and effectively.

An object of the present invention is to provide a combined electrophoresis chamber and analysis equipment and uses an automated monitoring system to control the electrophoresis process.

Another object of the present invention is to provide an automatic device to monitor and control the electrophoresis analysis by using automated engineering to control the mobility during electrophoresis as well as a monitoring sensor and to provide instant image scanning and storage in order to achieve the purpose of automatic monitoring of electrophoresis analysis.

Another object of the present invention is to provide an accurate electrophoresis device with precise control of the voltage and the electrophoresis mobility and uses a sensor to monitor the electrophoresis status, in order to effectively control the duration of electricity and to reduce the risk of improper resolution of the sample.

In order to achieve the objectives mentioned above, the device provides a combined electrophoresis chamber and analysis tank with automatic control and utilizes a sensor to monitor the electrophoresis analysis and imaging.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a three dimensional diagram showing an automatic inspection and imaging electrophoresis analysis device according to an embodiment of the present invention;

FIG. 2 is a three dimensional diagram showing an automatic inspection and imaging electrophoresis analysis device according to an embodiment of the present invention;

FIG. 3 is a cross-sectional view diagram showing an automatic inspection and imaging electrophoresis analysis device according to an embodiment of the present invention; and

FIG. 4 is a cross-sectional view diagram showing an automatic inspection and imaging electrophoresis analysis device during operation according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The automatic inspection and imaging electrophoresis analysis device of the present invention improves the traditional technology of electrophoresis analysis. With the conventional method, after completing electrophoresis, the sample is moved to an analysis tank to complete imaging. The process is complex and the duration of mobility is difficult to control, resulting in imaging with poor resolution. The present invention provides an automatic monitoring and imaging device with combined electrophoresis analysis and automatic control, in order to automatically monitor the processes of electrophoresis analysis and imaging so as to achieve accurate electrophoresis results.

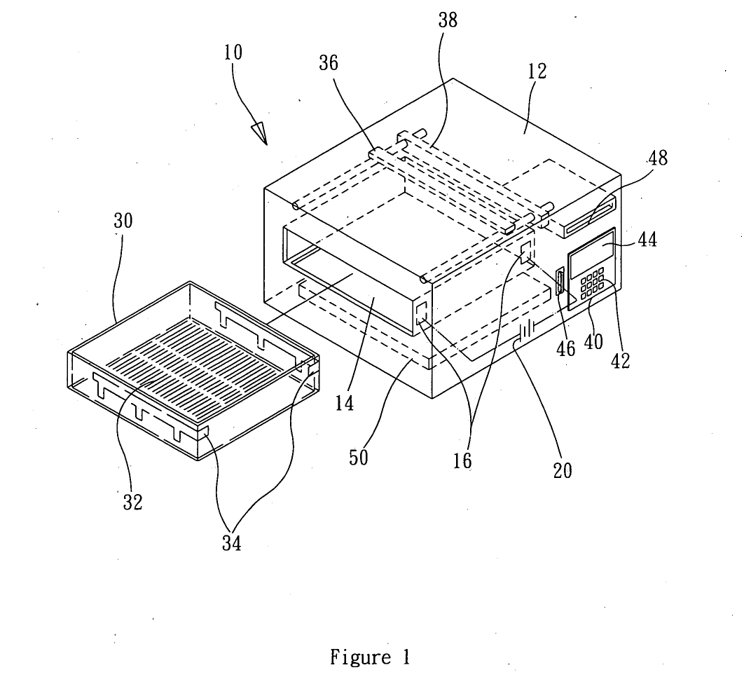

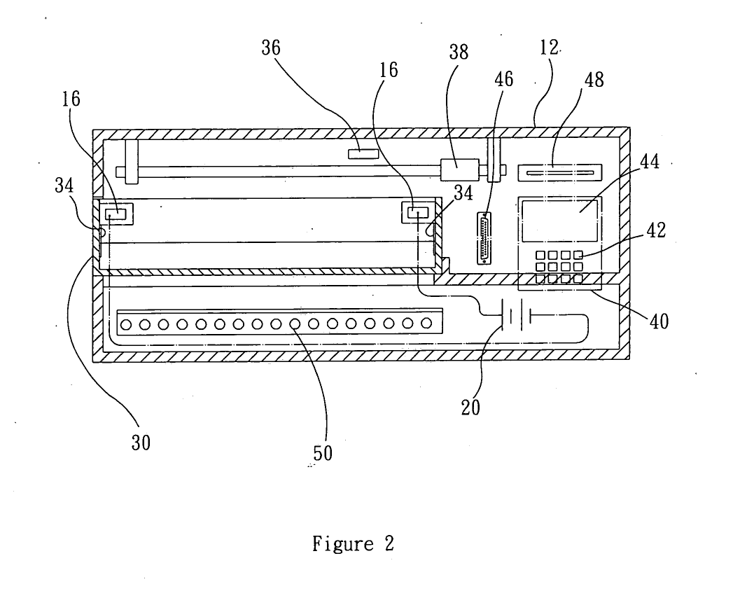

Refer to FIGS. 1 and 2, which are three dimensional diagrams showing an automatic inspection and imaging electrophoresis analysis device according to an embodiment of the present invention.

As shown in the figures, the electrophoresis device 10 which automatically monitors imaging comprises a main housing 12. A tray receiving opening 14 is placed in an upper portion of the main housing 12. There are at least two conductors or electrodes 16 around the tray receiving opening 14 depending on the electrophoresis method, such as single electrophoresis analysis or double electrophoresis analysis.

An electrophoresis tray 30 is provided as a container where a sample 32 is placed. The size of the electrophoresis tray 30 is slightly smaller than the tray receiving opening 14 of the main housing 12, so that the electrophoresis tray 30 can be placed in the tray receiving opening 14. At least two electrodes are placed on each side of the electrophoresis tray 30 relating to the locations of the conductors 16 mentioned above; so that when the electrophoresis tray 30 is placed in the tray receiving opening 14, the electrodes 34 contact the conductors 16. Electricity passes through the conductors 16 to the electrodes 34 and to the electrophoresis tray 30 to ensure the sample 32 has current flow from one end of the electrophoresis tray 30 to the other.

A sensor 36 is placed in the main housing 12 of the electrophoresis device 10 for monitoring the electrophoresis status. There is also a scanner 38 situated in the main housing 12 for scanning the electrophoresis results of the sample 32 in the electrophoresis tray 30, in order to capture an image for analysis. A control device 40 is provided for controlling operation of the electrophoresis device 10. The control device 40 comprises a keypad 42 and a display 44. The keypad 42 is for data input, and the screen 44 is for displaying the status. The control device 40 can be built into the main housing 12 or can be external to the main housing 12. For example, a PC, PDA or laptop can be used as the control device. An interface 46 is provided for connecting an external device such as a printer or storage device to the electrophoresis device 10

The electrophoresis device 10 also comprises a power supply 20, which connects to the parts in the electrophoresis tray 30 to satisfy the energy consumption requirements during operation and also for supplying power to the sensor 36 and scanner 38. The power supply 20 is built in the main housing or external, according to user's choice.

The electrophoresis device 10 further comprises a storage device 48 to store data, for example data to operate the control device 40, or the electrophoresis imaging data scanned by the scanner 38. The storage device can be built internally or externally.

A light source 50, such as UV light or visible light source, is provided to illuminate the sample and activate the dye used for electrophoresis, in order to obtain a high resolution image.

It should be noted that the material used for the electrophoresis tray 30 can be transparent.

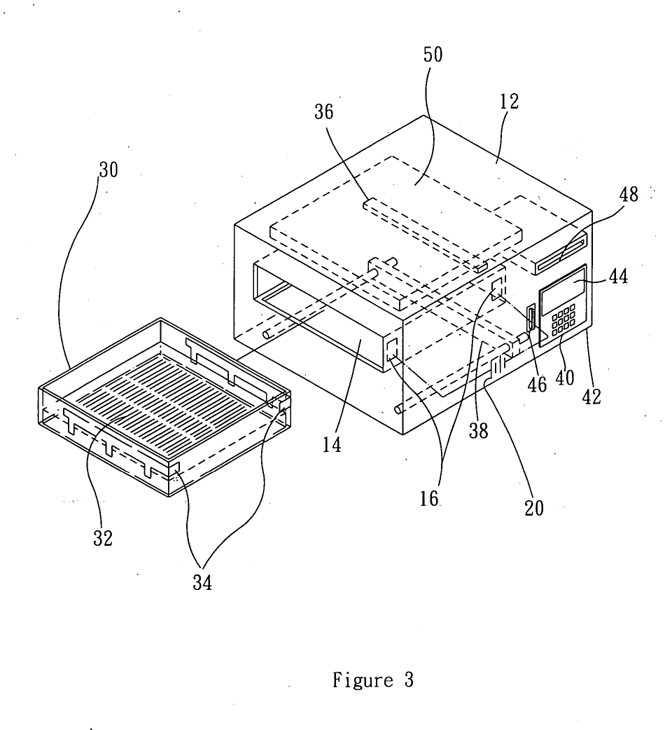

Refer to FIG. 3, which is a cross-sectional view diagram showing an automatic inspection and imaging electrophoresis analysis device according to an embodiment of the present invention.

The sensor 36, scanner 38 and light source 50 can be independent from the electrophoresis tray 30. Additionally, they can be either placed above or below the electrophoresis tray 30. If the light source 50 is placed above the electrophoresis tray 30, the sensor 36 and the scanner 38 are placed below the tray 30. Alternatively, if the light source 50 is placed below the electrophoresis tray 30, the sensor 36 and the scanner 38 are placed above the tray 30 in order to obtain high sensitivity and image resolution. Also, the positioning of the sensor 36 and the scanner 38 can be selected to obtain the best analysis results. For example, the sensor 36 can be positioned under the scanner 38 or above the scanner 38.

Furthermore, the device is highly configurable. For example, the power source 20, the control device 40 and the storage device 48 can be situated internally or externally, to provide users the freedom to configure the components of the electrophoresis device 10 accordingly.

Concluding the above, the invention uses an automated design to combine the electrophoresis chamber and the analysis equipment, and is equipped with useful functions such as time setting, instant analysis, image storage, automatic monitoring, etc. Utilizing these features, the device is more capable of controlling the electrophoresis results.

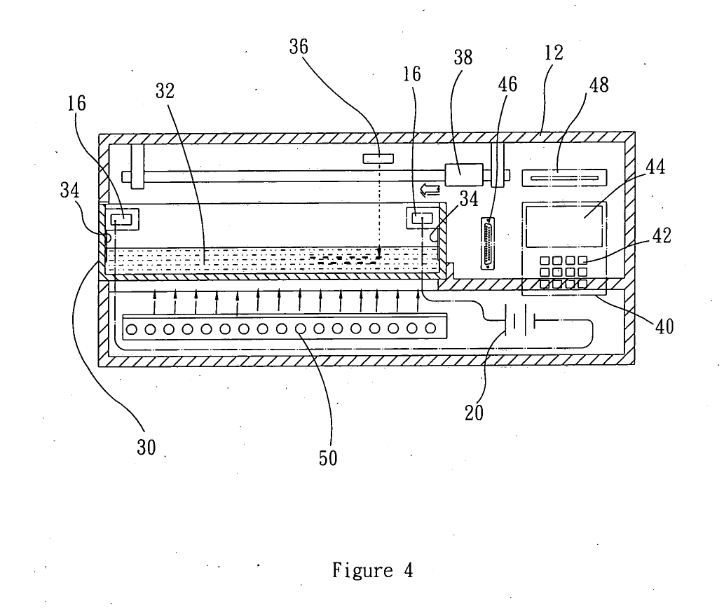

Refer to FIG. 4, which is a cross-sectional view diagram showing an automatic inspection and imaging electrophoresis analysis device during operation according to an embodiment of the present invention.

The time setting for electrophoresis analysis and voltage setting when performing electrophoresis analysis can not only be set for the time of sending electricity for electrophoresis, but also the voltage that the power source 20 supplies can be set according to the user in order to control the speed of mobility of the sample 32. Also, the device can be setup to provide different voltages at different times.

The duration of electrophoresis can also be control by the sensor 36 in the main housing. The sensor 36 can be a visible light sensor or a CCD. When performing electrophoresis, the sensor 36 can be set at a desired marked point. When the sensor 36 detects the distance that the electrophoresis mobility arrived at the marked point, the sensor can instantly control the actions of the power source 20, such as cutting off the external power supply; or turning on other components, like triggering the scanner 38 for instant electrophoresis imaging.

For instant imaging analysis, when the distance of electrophoresis mobility arrives at the marked point, the sensor 36 can trigger the scanner 38 to instantly proceed with scanning in order to obtain the electrophoresis image. The scanning time can also be set for during the electrophoresis process or the scanner 38 can function constantly or separately to obtaining electrophoresis images of different settings.

As described above, the device comprises a storage device 48. It can not only store data related to the electrophoresis device 10, for example operating data, but can also store data obtained from the electrophoresis imaging.. Having an internal storage device 48 overcomes the disadvantage of requiring an external storage device. The storage device 48 is for example, a hard disk drive, an optical disk writer, or a memory card device

The control device 40 comprises an input interface 42 such as a keypad and a display 44 to facilitate the input of the various settings mentioned above. It can also display the status of the electrophoresis device 10. Additionally, a PC, PDA, or notebook computer can be utilized as the control device 40, in order to provide users with various methods of control. Also, an interface port 46, for example a USB, IEEE1394, RS-232, or parallel port, is provided for connecting to an external device, such as printer, storage device, etc to facilitate print out image or data. In embodiments utilizing an external control device, the device 10 comprises a plurality of interface ports. For example, one interface port for connecting the device to a printer and another interface port for connecting the device to a notebook computer.

In summary, the present invention features a design combining the electrophoresis tank and analysis equipment in order to provide users with more accurate, safer and faster performance of electrophoresis analysis.

It will be apparent to those skilled in the art that various modifications and variations can be made to the present invention without departing from the scope or spirit of the invention. In view of the foregoing, it is intended that the present invention cover modifications and variations of this invention provided they fall

1. An automatic inspection and imaging electrophoresis device comprising:
a main housing with a tray receiving opening having at least two conductors in the tray receiving opening;
an electrophoresis tray for holding a sample, the electrophoresis tray having at least two electrodes situated so as to contact the at least two conductors when the electrophoresis tray is inserted into the tray receiving opening;
a sensor in the main housing for detecting movement of the sample in the electrophoresis tray;
a scanner in the main housing for obtaining an image of the sample in the electrophoresis tray;
a control device for controlling the operation of the electrophoresis device, and
a power supply for providing electricity to the electrophoresis device.

2. The automatic inspection and imaging electrophoresis device of claim 1, further comprising a storage device for storing data.

3. The automatic inspection and imaging electrophoresis device of claim 1, wherein the power supply is located inside the main housing.

4. The automatic inspection and imaging electrophoresis device of claim 1, wherein the power supply is external to the main housing.

5. The automatic inspection and imaging electrophoresis device of claim 1, further comprising a light source in the main housing.

6. The automatic inspection and imaging electrophoresis device of claim 5, wherein the light source is an ultraviolet light or a visible light.

7. The automatic inspection and imaging electrophoresis device of claim 1, wherein the electrophoresis tray is transparent.

8. The automatic inspection and imaging electrophoresis device of claim 7, wherein if the sensor and scanner are located above the electrophoresis tray, the light source is located below the electrophoresis tray, and if the sensor and the scanner are located below the electrophoresis tray, the light source is located above the electrophoresis tray.

9. The automatic inspection and imaging electrophoresis device of claim 1, wherein the sensor comprises a photodiode or charge-coupled device (CCD).

10. The automatic inspection and imaging electrophoresis device of claim 1, further comprising:
an input interface for inputting operation data; and
a display for displaying status of components of the electrophoresis device.

11. The automatic inspection and imaging electrophoresis device of claim 1, wherein the control device comprises an external computer.

12. The automatic inspection and imaging electrophoresis device of claim 1, wherein the control device comprises a portable electronic device.

13. The automatic inspection and imaging electrophoresis device of claim 12, wherein the portable electronic device comprises a personal digital assistant (PDA).

14. The automatic inspection and imaging electrophoresis device of claim 1, wherein the control device comprises a notebook computer.

15. The automatic inspection and imaging electrophoresis device of claim 1, further comprising an interface port for connecting an external device to the electrophoresis device.

16. An automatic inspection and imaging electrophoresis device comprising:
a main housing with a tray receiving opening having at least two conductors in the tray receiving opening;
an electrophoresis tray for holding a sample, the electrophoresis tray having at least two electrodes situated so as to contact the at least two conductors when the electrophoresis tray is inserted into the tray receiving opening;
a sensor in the main housing for detecting movement of the sample in the electrophoresis tray;
a scanner in the main housing for obtaining an image of the sample in the electrophoresis tray;
a control device for controlling the operation of the electrophoresis device; the control device comprising:
a keypad for inputting operation data; and
a display for displaying status of components of the electrophoresis device;
a power supply for providing electricity to the electrophoresis device;
a storage device for storing data;
a light source for supplying light; and
an interface port for connecting an external device to the electrophoresis device.
17. The automatic inspection and imaging electrophoresis device of claim 16, wherein the light source comprises an ultraviolet light or a visible light.
18. The automatic inspection and imaging electrophoresis device of claim 16, wherein the electrophoresis tray is transparent.
19. The automatic inspection and imaging electrophoresis device of claim 16, wherein if the sensor and scanner are located above the electrophoresis tray, the light source is located below the electrophoresis tray, and if the sensor and the scanner are located below the electrophoresis tray, the light source is located above the electrophoresis tray.
20. The automatic inspection and imaging electrophoresis device of claim 16, wherein the sensor comprises a photodiode or charge-coupled device (CCD).
21. The automatic inspection and imaging electrophoresis device of claim 16, wherein the control device comprises an external compute, a portable electronic device, a personal digital assistant, or a notebook computer.
